(19) United States
(12) Patent Application Publication
(10) Pub. No.: US 2026/0249118 A1
(43) Pub. Date: Aug. 27, 2026

(54) MOVABLE TRUCK HAVING WATER TANK FOR EXTINGUISHING ELECTRIC CAR FIRE

(71) Applicant: VISCARE CO.,LTD., Gwangyang-si (KR)

(72) Inventors: Jeong Min LEE, Suncheon-si (KR); Sang Yeul LEE, Gwangyang-si (KR); Kug Sang LEE, Seongnam-si (KR)

(21) Appl. No.: 18/856,684

(22) PCT Filed: Apr. 19, 2023
(86) PCT No.: PCT/KR2023/005288

§ 371 Date: Nov. 25, 2024

(30) Foreign Application Priority Data
Apr. 19, 2022 (KR) 10-2022-0048492

(51) Int. Cl. A62C 27/00; A62C 3/07

(52) U.S. Cl. CPC A62C 27/00; A62C 3/07

(57) ABSTRACT

The present invention relates to a mobile cart equipped with a water tank for extinguishing electric vehicle fires. More specifically, it pertains to a mobile cart that can be towed by a vehicle, where an electric vehicle experiencing a fire is loaded into a tank that is sealed in the front, rear, and both side directions, and in which fire-extinguishing water is supplied so that the battery of the electric vehicle is submerged.

The mobile cart equipped with a water tank for extinguishing electric vehicle fires, as per the present invention, allows for the rapid extinguishment of electric vehicle fires by loading an electric vehicle on fire into the tank and supplying fire-extinguishing water to the tank so that the electric vehicle's battery becomes submerged.

Additionally, after loading an electric vehicle on fire into the tank, the mobile cart of the present invention can be moved to a location where water supply is easily accessible, thereby enhancing fire extinguishing efficiency.

### TECHNICAL FIELD

The present invention relates to a mobile cart equipped with a water tank for extinguishing electric vehicle fires. More specifically, it pertains to a mobile cart that is towable by a vehicle, allowing fire-extinguishing water to be supplied to the water tank so that the battery of an electric vehicle loaded in the tank becomes submerged after being sealed in all directions (front, rear, left, and right) following loading in the case of a fire.

### BACKGROUND TECHNOLOGY

Conventionally, cars used internal combustion engines powered by gasoline or diesel fuel. However, due to the carbon dioxide emissions produced by internal combustion engines, the adoption of environmentally friendly energy vehicles, such as electric vehicles, has increased in recent years. As a result of this trend, with the issue of global warming, the movement to eliminate internal combustion vehicles is growing worldwide, while the spread of electric vehicles is steadily increasing each year, and it is expected that the market share of electric vehicles will continue to rise.

With the automobile industry declaring 2021 as the first year of widespread electric vehicle adoption, concerns over electric vehicle safety have grown. This is due to the lack of a viable solution to address immediate issues such as unexplained electric vehicle fires and the ensuing difficulties in suppression and rescue operations.

In terms of ignition factors for electric vehicles, electrical causes represented 58.0% as of 2021, primarily due to batteries, associated parts, or electrical shocks. Unknown causes accounted for 17.5%, with other factors including mechanical causes (14.5%), traffic accidents (7.0%), and negligence (3.0%).

Electric vehicles store very high amounts of energy in batteries positioned at the bottom of the vehicle. In the event of ignition caused by an accident or other reasons, the temperature of the heat-emitting point is extremely high, and even if the fire is seemingly extinguished, it is challenging to fully control due to the high-density arrangement of the batteries, which can result in reignition due to continued heat transfer.

Therefore, effective fire suppression for electric vehicles relies on lowering the overall temperature of the batteries, which often requires large amounts of water. Alternatively, a method has been applied in which the electric vehicle is submerged in water for fire suppression, as described in Korean Patent No. 10-2339405, “Structure for Electric Vehicle Fire Prevention,” or Korean Patent No. 10-2376222, “Cooling Tank for Stabilizing the Battery of a Fire-Damaged Electric Vehicle.”

However, the above structures are primarily installed on-site at the location of the fire without moving the burning electric vehicle, making them challenging to apply in confined spaces. Additionally, it is difficult to set up a water tank or cooling tank structure around a high-temperature electric vehicle after a fire has already started.

### DETAILED DESCRIPTION OF THE INVENTION

### Technical Problems

The purpose of this invention is to address the aforementioned issues. This invention aims to provide a mobile cart equipped with a water tank for extinguishing electric vehicle fires that is towable and movable. Additionally, this invention aims to provide a mobile cart in which after loading an electric vehicle that has caught fire, the designated area where the vehicle is loaded can be filled with fire-extinguishing water, allowing the electric vehicle's battery to be submerged, which makes it possible to extinguish the fire.

### Technical Solution

The mobile cart equipped with a water tank for extinguishing electric vehicle fires according to this invention includes: a tank with an inner space that can be opened or closed by a loading door that rotates from the rear side; multiple wheels attached to the tank that can roll on the ground; a towing unit connected to the front side of the tank, enabling connection to a towing vehicle at the front; a loading winch designed to pull an electric vehicle on fire into the tank opened at the rear side by the loading door, the winch having a hook at the end of a wire that can be wound or unwound; a fire extinguishing water supply unit that supplies fire extinguishing water to the tank, which is sealed in all side directions when the loading door is closed, allowing the battery of the loaded electric vehicle to be submerged in the water; a shaft coupling piece located at the lower front side of the tank, allowing the tank to rotate with respect to the towing unit; and a tilting drive cylinder, one end connected to the towing unit and the other end connected to the tank, enabling the tank to rotate slantly or horizontally with respect to the towing unit by expanding or contracting in length.

The fire extinguishing water supply unit may comprise; a hose connection pipe equipped with a hose connector that can connect to a fire hose extended from a hydrant or firefighting vehicle; and a first fire extinguishing water supply part that supplies fire extinguishing water to the inner space from the upper side of the tan. The first fire extinguishing water supply part may include: a first fire extinguishing water supply pipe with one side connected to the hose connection pipe and the other side branching out to a pair of second horizontal extension parts that extend along both sides in the width direction of the tank; multiple nozzle connection pipes that are branched at regular intervals from each of the second horizontal extension parts, and bent to face downward toward the lower part of the inner space; and multiple first supply nozzles attached to the other end of each nozzle connection pipe, which eject the fire extinguishing water toward the central width direction of the lower part of the inner space.

The fire extinguishing water supply unit may comprise: a hose connection pipe equipped with a hose connector that can connect to a fire hose extended from a hydrant or firefighting vehicle; and and a second fire extinguishing water supply part that supplies fire extinguishing water to the inner space from the lower side of the tank. The tank may include: a base that supports the loaded electric vehicle, extending in the front-rear direction, with a pipe receiving groove formed to recess downward from the center of the width, and elongated in the front-rear direction; a left wall and a right wall that extend upward in parallel from both ends of the base in the width direction, higher than the battery of the loaded electric vehicle in the inner space; and a front wall extending upward from the front end of the base, connecting the front ends of the left wall and the right wall, and being equal to or higher than them. The second fire extinguishing water supply part may include: a second fire extinguishing water supply pipe that extends in the longitudinal direction of the tank to be accommodated in the pipe receiving groove, protrudes forward from the front end of the base to connect to the hose connection pipe; and multiple second supply nozzles installed on the second fire extinguishing water supply pipe to eject fire extinguishing water into the inner space of the tank.

The mobile cart equipped with a water tank for extinguishing electric vehicle fires according to the present invention may further comprise a pulling direction-switching unit that can switch the direction of the wire extending to the rear side of the tank toward a direction crossing the longitudinal direction of the tank. The pulling direction-switching unit may include: a multi-stage support column which is mounted at the center of the rear width of the base that supports the loaded electric vehicle or on the side of the tank, and telescopically extendable in the longitudinal direction such that it can protrude rearward from the tank; and a direction-switching roller mounted on the upper portion of the lengthwise end of the multi-stage support column that protrudes rearward from the tank, capable of rotating around a vertical axis.

A wire support groove may be formed along the circumferential direction of the direction-switching roller, and the outer diameter of the upper part of the wire support groove is larger than the outer diameter of the lower part of the wire support groove.

The tank may further include; a base extending in the front-rear direction to support the loaded electric vehicle, and having multiple roller receiving grooves formed on each side in the width direction and spaced apart in the front-rear direction; and an auxiliary loading unit comprising multiple auxiliary loading rollers rotatably accommodated in each roller receiving groove; ratchet wheels connected to the axis of each auxiliary loading roller; and multiple stoppers that limit the backward rotation of the ratchet wheels by being rotatably mounted on one side of the tank and contacting the outer circumference of the ratchet wheels with multiple teeth.

### Effects of the Invention

The mobile cart equipped with a water tank for extinguishing electric vehicle fires according to this invention can quickly extinguish the fire of an electric vehicle by loading the vehicle into the tank and then supplying fire-extinguishing water until the battery is submerged. Additionally, after loading the electric vehicle with a fire incident into the tank, the mobile cart can be moved to a location where fire-extinguishing water can be easily supplied, enhancing fire suppression efficiency. Moreover, it can tow the electric vehicle targeted for fire suppression (e.g., parked in a parking lot) in a direction crossing the lengthwise direction of the tank, further improving loading efficiency into the tank and fire suppression efficiency.

### BRIEF DESCRIPTION OF THE DRAWINGS

FIG. 1 is a perspective view of the mobile cart equipped with a water tank for extinguishing electric vehicle fires according to the first embodiment of the invention.

FIG. 2 is a side cross-sectional view showing the state of an electric vehicle with a fire incident being loaded into the mobile cart equipped with a water tank for extinguishing electric vehicle fires depicted in FIG. 1, using a winch.

FIG. 3 is a side cross-sectional view showing the state of fire-extinguishing water filling the tank after the electric vehicle with a fire incident is loaded into the mobile cart equipped with a water tank for extinguishing electric vehicle fires depicted in FIG. 1.

FIG. 4 is a side cross-sectional view of the main part of the mobile cart equipped with a water tank for extinguishing electric vehicle fires according to the second embodiment of the invention.

FIG. 5 is a plan view showing the state of the mobile cart equipped with a water tank for extinguishing electric vehicle fires depicted in FIG. 4, towing a vehicle targeted for loading.

FIG. 6 is a perspective view of the main part of the mobile cart equipped with a water tank for extinguishing electric vehicle fires according to the third embodiment of the invention.

FIG. 7 is a perspective view of the main part of the mobile cart equipped with a water tank for extinguishing electric vehicle fires according to the fourth embodiment of the invention.

### BEST MODE OF THE INVENTION

The present invention's mobile cart, equipped with a water tank for extinguishing electric vehicle fires, will now be described in detail with reference to the attached drawings.

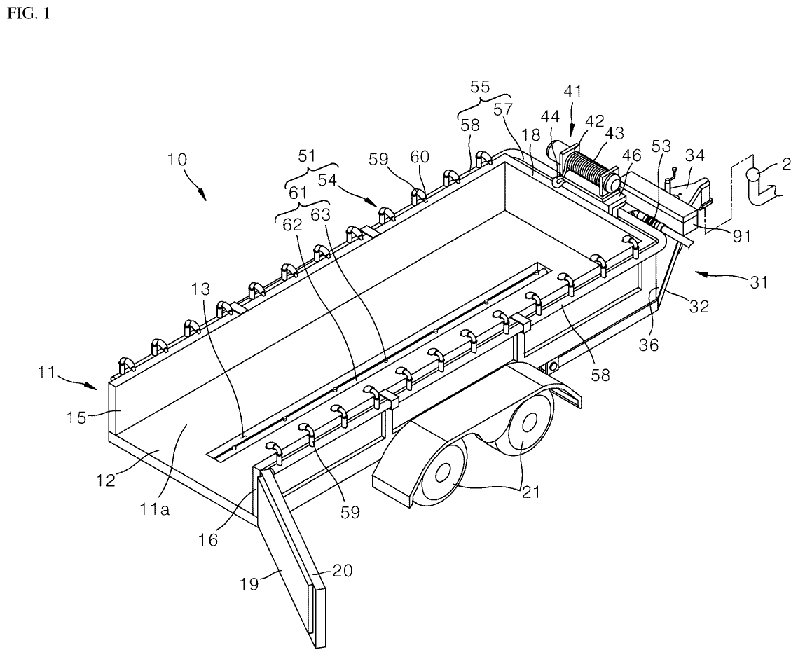

FIGS. 1 to 3 show a mobile cart (10) equipped with a water tank for extinguishing electric vehicle fires, according to the first embodiment of the present invention.

The mobile cart (10) equipped with a water tank for extinguishing electric vehicle fires according to the first embodiment of the present invention comprises: a tank (11) provided with a loading door (20) on the rear side that can be opened and closed, forming an interior space; a plurality of wheels (21) mounted on both sides of the tank (11), which can roll on the ground; a towing unit (31) connected to the front end of the tank, enabling the front side connection with a towing vehicle, while the rear side is connected in a manner that allows relative rotation with respect to the tank (11) from the lower front side of the tank; a loading winch (41) for pulling up an electric vehicle with a fire into the tank, which is open at the rear side when the loading door (20) is open; a winch support frame (46) mounted on the towing unit (31) or the front end side of the tank (11) and securing the winch (41) at a height above the tank (11); a fire-extinguishing water supply unit (51) that supplies fire-extinguishing water to the tank (11), which is sealed in the front, rear, left, and right directions when the loading door (20) is closed, so that the battery (not shown) of the electric vehicle (1) loaded into the tank (11) can be submerged in the fire-extinguishing water; and at least one tilting drive cylinder (81) with one end connected to the towing unit (31) and the other end connected to the tank (11), enabling the tank (11) to rotate slantly or horizontally relative to the towing unit (31) through length extension and contraction.

The tank (11) includes a base (12) that extends longitudinally with a certain width to support the loaded electric vehicle (1); left and right walls (15, 16) that extend in parallel above the battery of the loaded electric vehicle (1) in the inner space (11a) opened upwards from both ends of the base (12) in the width direction; a front end wall (18) extending from the front end of the base (12) at the same or higher height than the left and right walls (15, 16) and connecting the left and right walls (15, 16); and a loading door (20) that is rotatably mounted to either the left wall (15) or the right wall (16).

The base (12) extends longitudinally with a certain width, with a pipe receiving groove (13) formed at the center of the width, recessed downward and extending longitudinally.

Meanwhile, the pipe receiving groove (13) is linearly extended in the longitudinal direction of the base (12), however, unlike what is shown, it may also extend in a zigzag along the width direction of the base (12) while extending in the longitudinal direction of the base (12). Additionally, one side of the second fire-extinguishing water supply pipe (62, described below) accommodated in the pipe receiving groove (13) may also be formed to correspond to the pipe receiving groove.

Furthermore, the tank (11) is provided with multiple shaft coupling pieces (14) on both sides of the width direction at the lower front part of the base (12) for connection with the towing unit (31).

Although the loading door (20) is rotatably mounted to the right wall (16), unlike what is shown, it may also be rotatably mounted to the left wall (15).

When rotated to close the rear of the inner space (11a) of the tank, the loading door (20) is preferably extended to match the width of the base (12) so that it covers the rear ends of the left wall (14) and right wall (16) and maintains the same height as the left wall (14) and right wall (16).

Moreover, the tank (11) is equipped with a first waterproof member (19) in a plate shape that covers the surface facing the front of the rotated loading door (20) to seal the rear of the inner space (11a), fitted into the space formed by the base (12), the left wall (15), and the right wall (16).

The tank (11) may include locking means (not shown) that limit the rotation of the loading door (20) closing the rear of the inner space (11a).

The towing unit (31) includes a rotation support shaft (35) that passes through the shaft coupling piece (14); multiple inclined extension parts (32) that are connected to the rotation support shaft (35), mounted to be rotatable vertically relative to the base (12) at the lower front end of the base (12), and extend along the longitudinal extension line of the base (12) towards the center of the width of the base (12), becoming closer to each other as they extend forward; a towing coupler (34) fixed at the upper end of the meeting ends of the multiple inclined extension parts (32) and extending longitudinally to connect to the towing bar (2) of the towing vehicle at the front end; and a tongue jack (38), extending vertically behind the towing coupler (34) to support it on the ground. Additionally, the towing unit (31) may include a plate-shaped frame support plate (36) mounted at the top of the inclined extension parts (32).

The winch support frame (46) is mounted on the front-facing surface of the front end wall (18) to support the winch (41). Unlike what is shown, the lower part of the winch support frame (46) may be fixed to the frame support plate (36) of the towing unit (31). In this case, the winch support frame (46) is preferably extended vertically to support the winch (41) higher than the top of the tilted tank (11).

The loading winch (41) is a typical electric winch with a drum (42) for winding the wire (43) and a ring (44), and it can be electrically connected to a towing vehicle (not shown) with a towing bar (2) at the rear end to receive the necessary power for operation. Alternatively, the mobile cart (10) equipped with a water tank for extinguishing electric vehicle fires, according to the first embodiment of the present invention, may also be equipped with a battery to supply the power required for the operation of the loading winch (41).

Alternatively, unlike what is shown, the winch (41) may be directly supported and mounted on the upper part of the front end wall (18), and a wire penetration hole (not shown) may be formed at the center top of the front end wall (18) in the width direction, allowing a wire connected to the ring (42) of the winch (41) to pass through.

The fire-extinguishing water supply unit (51) includes a hose connection pipe (52) equipped with a hose connector (53) that can connect to a fire hose (3) extended from a fire hydrant or firefighting vehicle; a first fire-extinguishing water supply part (54) that supplies fire-extinguishing water into the inner space (11a) from the upper part of the tank (11); and a second fire-extinguishing water supply part (61) that supplies fire-extinguishing water into the inner space (11a) from the lower part of the tank (11).

The first fire-extinguishing water supply part (54) includes a first fire-extinguishing water supply pipe (55) that includes: a vertical extension part (56) that branches upward from one side of the hose connection pipe (52) and extends higher than the battery of the electric vehicle (2); a first horizontal extension part (57), the longitudinal center of which is connected to the vertical extension part (56) and extending horizontally in the width direction of the base (12); and multiple second horizontal extension parts (58) extending parallel to each other from both ends of the first horizontal extension part (57) along the extension direction of the left and right walls. The first fire-extinguishing water supply part (54) further includes multiple nozzle connection pipes (59) that are branched at intervals from each of the second horizontal extension parts (58) and are bent to face downward toward the lower part of the inner space (11a); and multiple first supply nozzles (60) mounted at the other end of each nozzle connection pipe (59) to discharge the fire-extinguishing water toward the center of the width direction of the lower part of the inner space (11a).

The nozzle connection pipe (59) protrudes upward from the second horizontal extension part (58) and is bent so that the other end faces the lower center of the width of the inner space (11a).

The second fire-extinguishing water supply part (61) includes a second fire-extinguishing water supply pipe (62), which extends longitudinally to be accommodated in the pipe receiving groove (13) of the tank (11), with multiple second supply nozzles (63) mounted to discharge fire-extinguishing water into the inner space (11a). The second fire-extinguishing water supply pipe protrudes through the front end of the base (12) from the pipe receiving groove (13) and extends toward the towing unit (31) side to connect with the hose connection pipe (52).

The hose connector (53) may have a standard female coupling structure for detachable connection to the male coupling (4) on one end of the fire hose (3). To prevent fire-extinguishing water from discharging through the hose connection pipe (52) from the tank when the hose connection port (53) is detached from the male coupling (4) of the fire hose (3), an open/close valve (not shown) may be installed on the hose connection pipe (52).

While not shown, the fire-extinguishing water supply unit (51) may include only the hose connection pipe (52) and the first fire-extinguishing water supply part (54) without the second fire-extinguishing water supply part (61). Alternatively, the fire-extinguishing water supply unit may be equipped with only the hose connection pipe (52) and the second fire-extinguishing water supply part (61) without the first fire-extinguishing water supply part (54).

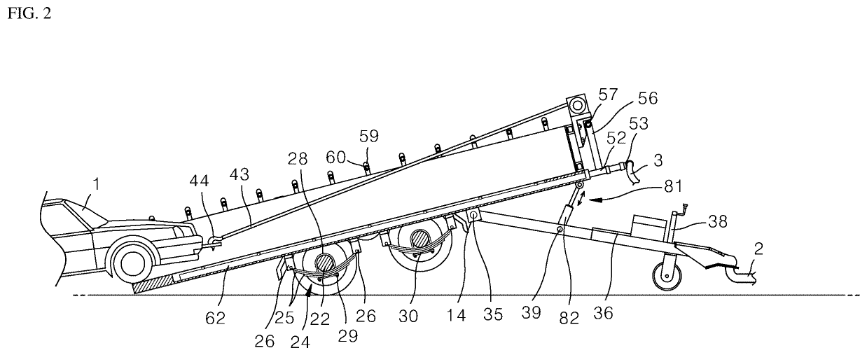

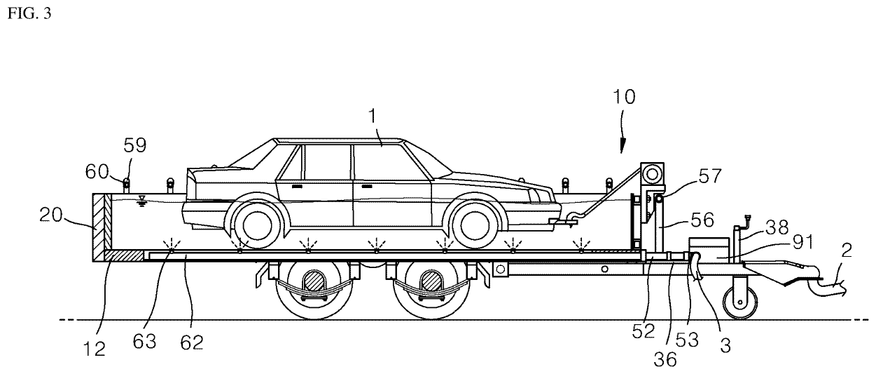

As shown in FIGS. 2 and 3, the pair of wheels arranged on both sides of the width direction of the base (11) are connected by a wheel shaft (22), which is supported by a leaf spring unit (24) consisting of multiple stacked leaf springs (25). Both sides of the leaf spring unit (24) are connected to a pair of support bars (26) extending in the width direction of the base (11) on the bottom of the base (11) and spaced apart front-to-back. The mobile cart (10) equipped with a water tank for extinguishing electric vehicle fires according to the first embodiment of the present invention may include U-bolts (28) housing the wheel shaft (22), a restraining plate (30) connecting both ends of the U-bolts (28) extending downward relative to the leaf spring unit (24), and restraining nuts (29) coupled to the U-bolts (28) extending downward relative to the restraining plate (30).

One side of the tilting drive cylinder (81) is vertically rotatably connected to the cylinder support shaft (39), connecting the multiple inclined extension parts (32), and the other side is vertically rotatably connected to the front end of the base to be positioned forward of the one side.

The mobile cart (10) equipped with a water tank for extinguishing electric vehicle fires, according to the first embodiment of the present invention, may include a battery (not shown) mounted at the top of the towing unit (31) to supply the power required for operating the loading winch (41), positioned between the tongue jack (38) and the winch (41), and a power case (91) containing a pump or control valve for supplying fluid required for the length expansion of the tilting drive cylinder (81).

The fluid supply unit that supplies fluid for the length expansion of the tilting drive cylinder (81) includes first and second fluid supply lines connected to both ends of the cylinder body (82) of the tilting drive cylinder (81); a fluid storage tank for supplying fluid to the first and second fluid supply lines; a pump for pumping fluid stored in the fluid storage tank to either the first or second fluid supply line; and a control valve to open and close the first or second fluid supply line.

Additionally, the mobile cart (10) equipped with a water tank for extinguishing electric vehicle fires, according to the first embodiment of the present invention, may include an operation unit (not shown) to control the operation of the pump and control valve for the operation of the winch (41) and the length expansion of the tilting drive cylinder (81).

The mobile cart (10) equipped with a water tank for extinguishing electric vehicle fires, according to the first embodiment of the present invention, can extinguish the fire quickly by loading an electric vehicle that has caught fire into the tank, then supplying fire-extinguishing water to the tank so that the electric vehicle's battery is submerged.

Furthermore, the mobile cart (10) equipped with a water tank for extinguishing electric vehicle fires, according to the first embodiment of the present invention, can improve the efficiency of fire suppression by loading an electric vehicle that has caught fire into the tank, then moving it to a location where it is easy to supply fire-extinguishing water.

Additionally, the mobile cart (10) equipped with a water tank for extinguishing electric vehicle fires, according to the first embodiment of the present invention, can improve safety by moving to a safe location while in a state where fire-extinguishing water is supplied, submerging the battery of the electric vehicle that has caught fire in the tank.

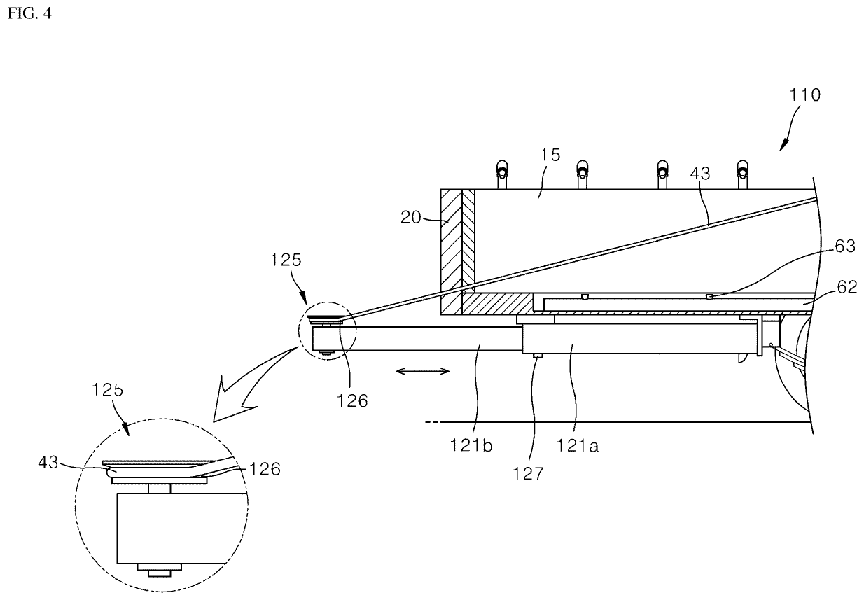

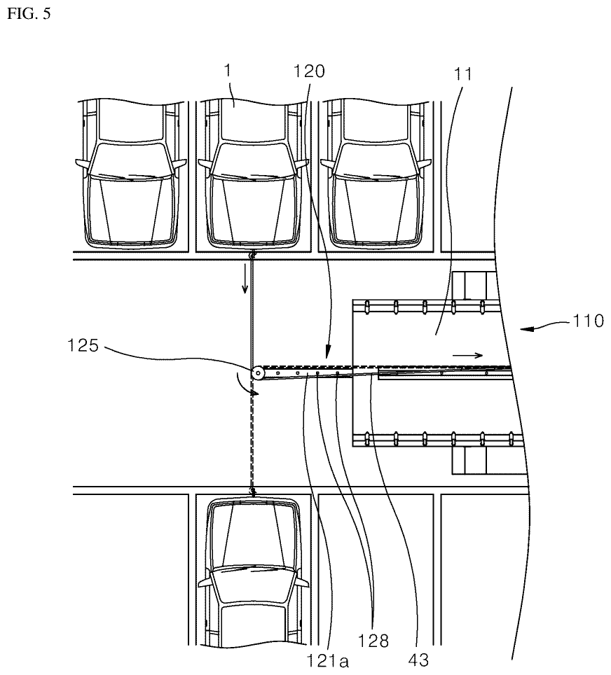

Meanwhile, FIGS. 4 and 5 show the mobile cart (110) equipped with a water tank for extinguishing electric vehicle fires, according to the second embodiment of the present invention. The mobile cart (110) equipped with a water tank for extinguishing electric vehicle fires, according to the second embodiment of the present invention, has the same structure as the mobile cart (10) according to the first embodiment, except for further comprising a pulling direction-switching unit (120) that can switch the wire (43) of the winch (41), which extends rearward from the tank (11), toward a direction crossing the longitudinal direction of the tank (1), enabling it to move an electric vehicle (1) that has caught fire and is parked in a direction crossing the longitudinal direction of the tank (11).

The pulling direction-switching unit (120) includes a multi-stage support column (121) mounted at the center in the width direction of the bottom rear end of the base (12) and telescopically extendable in the longitudinal direction, such that it can protrude rearward from the tank (11); and a direction-switching roller (125) mounted rotatably around a vertical axis on the upper surface of the lengthwise end of the multi-stage support column (121) that protrudes rearward from the tank (11) when the multi-stage support column (121) is extended.

The multi-stage support column (121) comprises a two-stage structure in which the second-stage support column (121b) retracts into and extends from the first-stage support column (121a) fixed to the base (12) of the tank (11). The direction-switching roller (125) is mounted on the upper surface of the end of the second-stage support column (121b) facing rearward.

Unlike what is shown, the multi-stage support column (121) may be configured as a structure with three or more stages. For example, the multi-stage support column (121) may further include a third-stage support column retractable into and extendable from the second-stage support column (121b), and a fourth-stage support column retractable into and extendable from the third-stage support column (not shown). In this case, the direction-switching roller (125) is mounted on the upper surface of the end of the fourth-stage support column facing rearward.

To prevent the wire (43) from disengaging, a wire support groove (126) is formed along the circumferential direction of the direction-switching roller (125) at the center in the width direction. Preferably, as shown, the outer diameter of the upper part of the wire support groove (126) is formed larger than the outer diameter of the lower part of the wire support groove (126).

After the length of the multi-stage support column (121) is adjusted by manual operation, the length can be fixed with a pin (127) on the first-stage support column (121a). A pin through-hole (128) is formed at intervals through the first-stage support column (121a) in the vertical direction.

Unlike what is shown, the multi-stage support column (121) may also be configured as a common double-acting telescopic cylinder structure capable of length expansion and contraction by hydraulic pressure. The double-acting telescopic cylinder structure can adopt the structure disclosed in Korean Utility Model Registration No. 20-0326727, but is not limited to this structure if it can be extended or retracted by fluid. In this case, the mobile cart (110) equipped with a water tank for extinguishing electric vehicle fires, according to the second embodiment of the present invention, may further include third and fourth fluid supply lines extending to both ends of the first-stage support column in the length direction and connected to the pump and control valve of the fluid supply unit described in the first embodiment of the present invention (not shown).

The mobile cart (110) equipped with a water tank for extinguishing electric vehicle fires, according to the second embodiment of the present invention, as shown in FIG. 5, can further improve the efficiency of loading and fire suppression of electric vehicles by hanging the wire (43) on the direction-switching roller (125) to pull the electric vehicle (1) that needs fire suppression, parked in a parking lot, in a direction crossing the longitudinal direction of the tank (11).

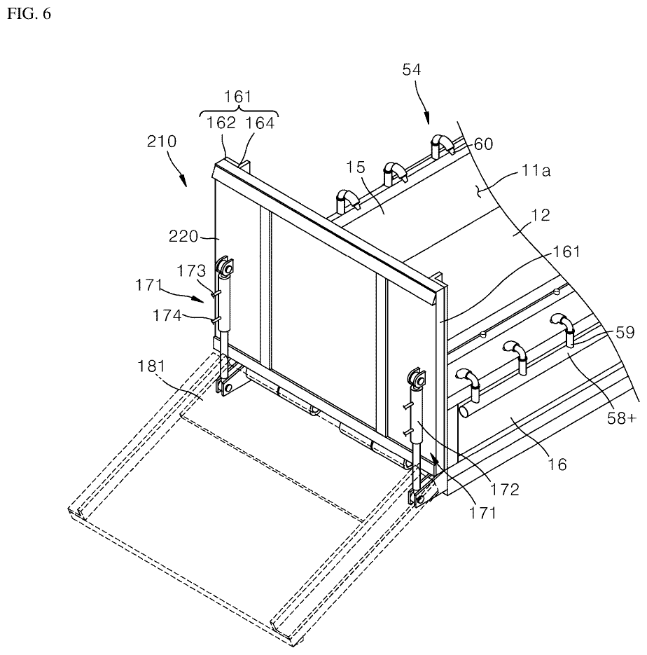

Meanwhile, FIG. 6 shows the mobile cart (210) equipped with a water tank for extinguishing electric vehicle fires, according to the third embodiment of the present invention. The same reference numerals are used for components that have the same function as those in the previously shown drawings.

The mobile cart (210) equipped with a water tank for extinguishing electric vehicle fires, according to the third embodiment of the present invention, has the same structure as the mobile cart (10) according to the first embodiment, except that it further includes a loading door (220) mounted rotatably up and down on the rear end side of the base (12) to form a ramp touching the ground for loading the electric vehicle (1) when rotated to open the rear of the tank (11), and it further includes a first waterproof member (161), a second waterproof member (181), and a rotation control cylinder (171).

The first waterproof member (161) and the second waterproof member (181) allow the inner space (11a) of the tank (11) to be sealed when the loading door (220) is rotated vertically.

The first waterproof member (161) is mounted on both sides in the width direction of the inner surface of the loading door (220), facing the left wall (15) and right wall (16) of the tank (11) when the loading door (220) is rotated vertically to close the rear side of the tank (11), to seal the rear side of the tank (11).

The second waterproof member (181) extends between the first waterproof members (161) on the inner surface of the loading door (220) and the rear end side of the base (12), and is formed from a material such as rubber, which can bend when the loading door (220) is rotated vertically.

The first extension part (162) of the first waterproof member (161) is mounted on the inner surface of the loading door (220) and has a width greater than the thickness of the left and right side walls in the width direction of the tank (11), allowing it to contact the left wall and right wall when the loading door (20) rotates vertically to close the rear of the tank (11). The first extension part (162) protrudes inward from both side walls in the width direction of the tank (11). The second extension part (164) of the first waterproof member (161), orthogonal to the first extension part (162), protrudes toward the inner surface of the loading door (220) from one end of the first extension part (162) and covers the inner surfaces of the left and right walls of the tank (11) when the loading door (220) rotates vertically.

The loading door (220) can rotate vertically to form a ramp when the end of the door is engaged with a hook (42) of the loading winch (41) is engaged, allowing it to be operated by the loading winch (41). Alternatively, as shown in FIG. 6, the loading door (220) may be rotated by the length expansion and contraction of the rotation control cylinder (171). The fifth and sixth fluid supply lines (173, 174) connected to both ends of the cylinder body (172) of the rotation control cylinder (171) can be connected to the pump and control valve of the fluid supply unit mentioned above.

Meanwhile, although not shown, the mobile cart (210) equipped with a water tank for extinguishing electric vehicle fires, according to the third embodiment of the present invention, may further include the direction-switching unit (120) of the second embodiment of the present invention. In this case, multiple direction-switching units (120) may be provided and mounted on the left wall (15) and right wall (16) of the tank (11).

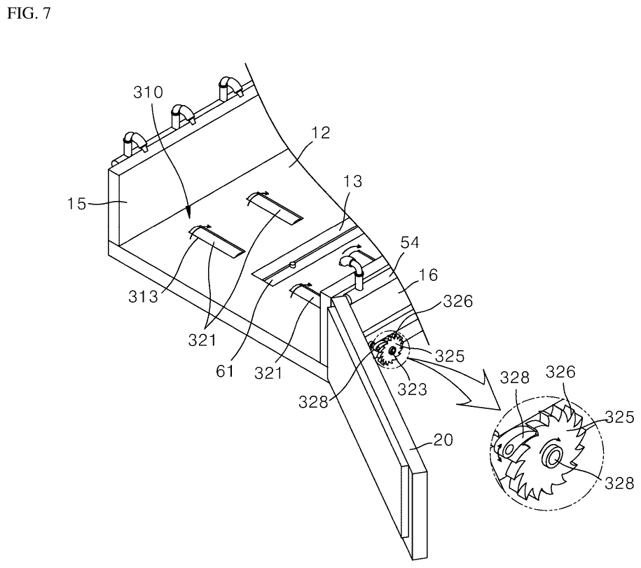

Meanwhile, FIG. 7 shows the mobile cart (310) equipped with a water tank for extinguishing electric vehicle fires, according to the fourth embodiment of the present invention.

The mobile cart (310) equipped with a water tank for extinguishing electric vehicle fires, according to the fourth embodiment of the present invention, has the same structure as the mobile cart (10) equipped with a water tank for extinguishing electric vehicle fires according to the first embodiment, except for further comprising an auxiliary loading unit (320) to assist in loading an electric vehicle (1) into the tank (11), and a roller receiving groove (313) formed in the base (12) to receive the auxiliary loading rollers (321) of the auxiliary loading unit (320).

As shown in FIG. 7, the roller receiving grooves (313) are formed along both sides of the width direction of the base (12) and arranged in multiple positions along the front-rear direction.

The auxiliary loading unit (320) includes multiple auxiliary loading rollers (321) rotatably accommodated in each roller receiving groove (313), multiple roller connecting shafts (323) directly coupled or gear-connected to the shafts (not shown) of the auxiliary loading rollers (321), multiple ratchet wheels (325) mounted on each roller connecting shaft (323) and having multiple teeth (326) formed around the outer circumferential surface of each ratchet wheel (325), and multiple stoppers (328) mounted on one side of the tank (11) and positioned to contact the outer circumferential surface of each ratchet wheel (325) to restrict the rotation of the ratchet wheel (325) rearward.

Although not shown, the mobile cart (310) equipped with a water tank for extinguishing electric vehicle fires, according to the fourth embodiment of the present invention, may further include a drive motor to provide driving force to rotate the ratchet wheels (325) forward by connecting a drive shaft to the roller connecting shaft (323) through gears.

This invention has been described with reference to the embodiments shown in the drawings, but this is merely illustrative, and it should be understood that various modifications and equivalent embodiments are possible to those skilled in the art. Accordingly, the true scope of protection for the present invention should be defined solely by the attached claims.

1. A mobile cart equipped with a water tank for extinguishing electric vehicle fires, comprising:
a tank with an inner space that can be opened or closed by a loading door that rotates from the rear side;
multiple wheels attached to the tank that can roll on the ground;
a towing unit connected to the front side of the tank, enabling connection to a towing vehicle at the front;
a loading winch designed to pull an electric vehicle on fire into the tank opened at the rear side by the loading door, the winch having a hook at the end of a wire that can be wound or unwound;
a fire extinguishing water supply unit that supplies fire extinguishing water to the tank, which is sealed in all side directions when the loading door is closed, allowing the battery of the loaded electric vehicle to be submerged in the water;
a shaft coupling piece located at the lower front side of the tank, allowing the tank to rotate with respect to the towing unit; and
a tilting drive cylinder, one end connected to the towing unit and the other end connected to the tank, enabling the tank to rotate slantly or horizontally with respect to the towing unit by expanding or contracting in length.

2. The mobile cart equipped with a water tank for extinguishing electric vehicle fires according to claim 1, wherein the fire extinguishing water supply unit comprises:
a hose connection pipe equipped with a hose connector that can connect to a fire hose extended from a hydrant or firefighting vehicle; and
a first fire extinguishing water supply part that supplies fire extinguishing water to the inner space from the upper side of the tank,
the first fire extinguishing water supply part includes:
a first fire extinguishing water supply pipe with one side connected to the hose connection pipe and the other side branching out to a pair of second horizontal extension parts that extend along both sides in the width direction of the tank;
multiple nozzle connection pipes that are branched at regular intervals from each of the second horizontal extension parts, and bent to face downward toward the lower part of the inner space; and
multiple first supply nozzles attached to the other end of each nozzle connection pipe, which eject the fire extinguishing water toward the central width direction of the lower part of the inner space.

3. The mobile cart equipped with a water tank for extinguishing electric vehicle fires according to claim 1, wherein the fire extinguishing water supply unit comprises:
a hose connection pipe equipped with a hose connector that can connect to a fire hose extended from a hydrant or firefighting vehicle; and
and a second fire extinguishing water supply part that supplies fire extinguishing water to the inner space from the lower side of the tank,
the tank includes:
a base that supports the loaded electric vehicle, extending in the front-rear direction, with a pipe receiving groove formed to recess downward from the center of the width, and elongated in the front-rear direction;
a left wall and a right wall that extend upward in parallel from both ends of the base in the width direction, higher than the battery of the loaded electric vehicle in the inner space; and
a front wall extending upward from the front end of the base, connecting the front ends of the left wall and the right wall, and being equal to or higher than them,
the second fire extinguishing water supply part includes:
a second fire extinguishing water supply pipe that extends in the longitudinal direction of the tank to be accommodated in the pipe receiving groove, protrudes forward from the front end of the base to connect to the hose connection pipe; and
multiple second supply nozzles installed on the second fire extinguishing water supply pipe to eject fire extinguishing water into the inner space of the tank.

4. The mobile cart equipped with a water tank for extinguishing electric vehicle fires according to claim 1, further comprising a pulling direction-switching unit that can switch the direction of the wire extending to the rear side of the tank toward a direction crossing the longitudinal direction of the tank,
the pulling direction-switching unit includes:
a multi-stage support column which is mounted at the center of the rear width of the base that supports the loaded electric vehicle or on the side of the tank, and telescopically extendable in the longitudinal direction such that it can protrude rearward from the tank; and
a direction-switching roller mounted on the upper portion of the lengthwise end of the multi-stage support column that protrudes rearward from the tank, capable of rotating around a vertical axis.

5. The mobile cart equipped with a water tank for extinguishing electric vehicle fires according to claim 4, wherein a wire support groove is formed along the circumferential direction of the direction-switching roller, and
the outer diameter of the upper part of the wire support groove is larger than the outer diameter of the lower part of the wire support groove.

6. The mobile cart equipped with a water tank for extinguishing electric vehicle fires according to claim 1, wherein the tank further includes:
a base extending in the front-rear direction to support the loaded electric vehicle, and having multiple roller receiving grooves formed on each side in the width direction and spaced apart in the front-rear direction; and
an auxiliary loading unit comprising multiple auxiliary loading rollers rotatably accommodated in each roller receiving groove; ratchet wheels connected to the axis of each auxiliary loading roller; and multiple stoppers that limit the backward rotation of the ratchet wheels by being rotatably mounted on one side of the tank and contacting the outer circumference of the ratchet wheels with multiple teeth.
